(19) United States
(12) Patent Application Publication
(10) Pub. No.: US 2023/0069982 A1
(43) Pub. Date: Mar. 9, 2023

(54) METHOD AND SYSTEM FOR RENAMING INSTRUCTIONS RELATED TO FIXED CONSTANTS

(71) Applicant: Guangdong StarFive Technology Co., Ltd, Foshan (CN)

(72) Inventors: Quansheng Liu, Shanghai (CN); Hongbin Yu, Beijing (CN); Lei Liu, Beijing (CN)

(73) Assignee: Guangdong StarFive Technology Co., Ltd, Foshan (CN)

(21) Appl. No.: 17/981,340

(22) Filed: Nov. 4, 2022

Related U.S. Application Data
(63) Continuation of application No. PCT/CN2021/128673, filed on Nov. 4, 2021.

(30) Foreign Application Priority Data
Mar. 22, 2021 (CN) 202110299925.0

(51) Int. Cl. G06F 9/30; G06F 9/38

(52) U.S. Cl. CPC G06F 9/30145; G06F 9/384

(57) ABSTRACT

The invention relates to the technical field of microprocessors, in particular to a renaming method and system of fixed constant related instructions. The invention classifies the instructions in the decoder according to the characteristics of the instructions, and selects the instructions with fixed constants. In the renaming stage, the invention maps the source register and the destination register of such instructions to different fixed constant physical registers according to different fixed constants, updates the register renaming mapping tables SPEC_MAP and ARCH_MAP, and releases the physical registers corresponding to the fixed constant when the instruction is submitted, thereby realizing the function of the instruction. The invention classifies the instruction, and the fixed constant instruction does not need to enter the execution unit, but realizes the execution of the instruction through the renaming method, and the instruction execution efficiency is high.

### TECHNICAL FIELD

The invention relates to the technical field of microprocessors, in particular to a method and system for renaming instructions related to fixed constants.

### BACKGROUND TECHNOLOGY

After more than 50 years of development, the architecture of microprocessor has experienced vigorous development along with the semiconductor technology, from single-core to physical multi-core and logical multi-core; from sequential execution to out-of-order execution; from single-issue to multi-issue. With the increasing requirements of data centers and scientific computing, the higher the performance requirements of division and remainder instructions. At the same time, the proportion of division and remainder instructions in the instruction increases gradually. The execution cycle of division and remainder instructions is relatively long, while the execution cycle is related to data, and the execution cycle is variable. These factors have a great influence on the performance of CPU.

The existing microprocessors can not classify the instructions, and all instructions are unified to the execution unit, which can not eliminate the execution of invalid instructions.

### SUMMARY OF THE INVENTION

In view of the deficiency of the prior art, the invention discloses a renaming method and a system of fixed constant related instructions, which are used to solve the problem that the existing microprocessor can not classify the instructions, and all instructions are uniformly executed into the execution unit unable to eliminate the problem of invalid instruction execution.

The invention is realized through the following technical proposal:

In the first aspect, the invention discloses a renaming method for fixed constant related instructions, which comprises the following steps:

According to the characteristics of instructions, S1 decoder classifies instructions and filters out instructions with fixed constants.

In the renaming phase, S2 maps the source register and destination register of the filter instruction in S1 to different fixed constant physical registers according to different fixed constants.

The S3 update register renames the mapping tables SPEC_MAP and ARCH_MAP to release the physical register corresponding to the fixed constant when the instruction is submitted.

The S4 instruction reads the physical register stack according to the physical register of the source register or obtains the source Operand by executing the instruction execution result of the Forward channel of the execution unit.

When the execution unit is completed, the S5 instruction writes the physical register stack according to the physical register of the destination register.

The 6 carries the Forward instruction execution result to the pipeline, relies on the instruction to get the instruction execution result, and then realizes the function of the instruction.

Further, each instruction gets the physical register corresponding to the source Operand and the destination register in the renaming stage, and the physical register of the source register is obtained from the renamed mapping table or the idle physical register queue according to the correlation of the instruction. the physical register of the destination register is the newly allocated idle physical register, which is obtained from the idle physical register queue.

Furthermore, before the register is renamed, it is determined whether the source Operand or the destination register of the instruction is a fixed constant according to the characteristics of the instruction, and whether a fixed constant value of 0, a constant value of 1, a constant value of e, a constant value of e, and a logarithm Loge (2) with constant e as base 2 are often found in the instruction.

Further, it is assumed that the instructions inst0, inst1, inst2 and inst3 in the renaming stage simultaneously perform fixed constant judgment to determine whether the source operand and destination operation of inst0 are fixed constants CONST1, CONST1, CONST2, CONSTN-1. When R1_0 or R2_0 in inst0 is a fixed constant, the physical register of R1_0 or R2_0 is mapped to the position of the fixed constant;

Assuming that when R1_0 is a fixed constant CONST0, the value of the physical register is 0;

Assuming that when R1_0 is a fixed constant CONST1, the value of the physical register is 1;

Assuming that when R1_0 is a fixed constant CONST2, the value of the physical register is 2;

Assuming that when R1_0 is a fixed constant CONSTN-1, the value of the physical register is N−1.

Further, judging R2_0, if it can be judged that the execution result of inst0 is a fixed constant, then inst0 does not need to apply for a new free physical register. inst0 maps the SPEC_MAP and ARCH MAP of RD_0 to the position of a fixed constant, and releases the physical register that RD_0 was swapped in ARCH MAP. When it is judged that the execution result of inst0 is a constant, the physical register of RD_0 is mapped to the physical register of this fixed constant. When implementing a specific instruction set, it is determined whether the source operand of the instruction, that is, the destination register, is a fixed constant according to the characteristics of the instruction.

Further, judging whether the source operand and destination operation of inst1, inst2 and inst3 are fixed constants CONST0, CONST1, CONST2, CONSTN-1. If R1_1 or R2_1 is a fixed constant, R1_1 or R2_1 is mapped to the corresponding fixed constant. When R1_1 is a fixed constant of 0, and R2_1 is not a fixed constant, if inst1 is a MOV instruction at this time, it just satisfies that R2_1 is equal to RD_0, and RD_0 is mapped to a fixed constant. At this time, the physical register RD_1 of inst1 is also mapped to the fixed constant mapped by RD_0, RD_0 and RD_1 are mapped to the same fixed constant, the architectural registers of RD_0 and R2_1 are mapped to the physical register address of the fixed constant, and RD_0 and RD_0 in SPEC_MAP and ARCH MAP are updated. The mapping relationship of R2_1. The judgment process of Inst2 is completely similar to that of inst0 and inst. It needs to judge whether inst2 has the same fixed constant as inst0 and inst1, and inst3 also needs to determine whether inst3 has the same fixed constant as inst0, inst1 and inst2.

Further, the instruction contains a source Operand and a destination register. Before the instruction enters the execution unit, all source operands need to be obtained. After the operands of the instructions in the reservation station are ready to be completed, they are transmitted to the execution unit for execution. After the execution is completed, the execution result is written to the destination register and submitted in sequence.

In a second aspect, the invention discloses a renaming system of fixed constant related instructions, which is used to execute a renaming method of fixed constant related instructions described in the first aspect, comprising a register, a decoder and an execution unit.

Further, the register includes an architecture register and a physical register. In the renaming phase, the architecture register of the instruction destination register is mapped to a physical register and updated to the rename mapping table SPEC_MAP. After the instruction execution is completed, it is sequentially submitted in the reorder cache, and the architecture register of the instruction destination register is mapped to ARCH_MAP.

The beneficial effects of the invention are:

The invention classifies the instruction, and the fixed constant instruction does not need to enter the execution unit, but realizes the execution of the instruction through the renaming method, and the instruction execution efficiency is high.

### DESCRIPTION OF DRAWINGS

In order to more clearly illustrate the technical scheme in the embodiment of the present invention or the prior art, the drawings that need to be used in the embodiment or the prior art description will be briefly introduced below. It is obvious that the drawings described below are only some embodiments of the invention, and other drawings can be obtained according to these drawings without creative work for those skilled in the art.

FIG. 1 is a diagram defining the instruction format of an embodiment of the present invention.

FIG. 2 is a register rename map of an embodiment of the present invention.

FIG. 3 is a register constant mapping diagram of an embodiment of the present invention.

FIG. 4 is a fixed constant execution pipeline diagram for registers of the embodiment of the present invention.

FIG. 5 is a constant dependent instruction dependency diagram of an embodiment of the present invention.

FIG. 6 is a physical register mapping diagram of the RISC V instruction example of the embodiment of the present invention.

### DETAILED DESCRIPTION

In order to make the purpose, technical scheme and advantages of the embodiment of the invention more clear, the technical scheme in the embodiment of the invention will be described clearly and completely in combination with the drawings in the embodiment of the invention. It is clear that the described embodiments are some embodiments of the present invention but not all embodiments. Based on the embodiments of the invention, all other embodiments obtained by ordinary technicians in the field without creative work fall within the scope of the protection of the invention.

Embodiment 1

This embodiment discloses a new method for realizing instructions with fixed constants through a method of renaming The decoder classifies the instructions according to the characteristics of the instructions, and filters out the instructions with fixed constants. In the renaming phase, it maps the source registers and destination registers of such instructions to different fixed constant physical registers according to different fixed constants, updates the register renaming mapping table SPEC_MAP and ARCH_MAP, and releases the physical register corresponding to the fixed constant when the instruction is submitted, thereby realizing the function of the instruction.

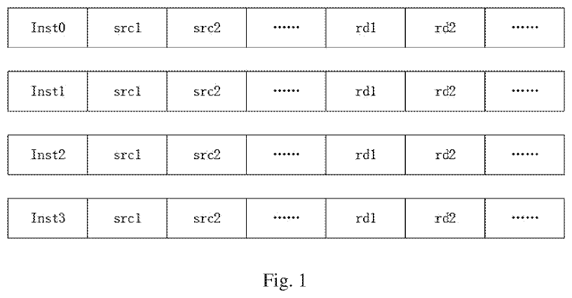

Different instruction sets define different instruction formats, no matter which instruction set, the instruction format including register-related instructions is shown in FIG. 1. The instruction contains source operands src0, src1, . . . and destination registers rd1, rd2, . . . All source operands need to be obtained before the instruction enters the execution unit. After the operands of the instructions in the reservation station are ready to be completed, they are transmitted to the execution unit for execution. After the execution is completed, the execution result is written to the destination register and submitted in order.

In the processor architecture that supports out-of-order execution, each instruction gets the physical register corresponding to the source Operand and the destination register in the renaming phase. The physical register of the source register is obtained from the renamed mapping table or the idle physical register queue according to the correlation of the instruction. The physical register of the destination register is the newly allocated idle physical register, that is, obtained from the idle physical register queue. The instruction reads the physical register stack according to the physical register of the source register or obtains the source Operand by executing the instruction of the Forward channel of the execution unit. When the instruction is completed in the execution unit, the physical register stack is written according to the physical register of the destination register. At the same time, the execution result of the Forward instruction is reached to the pipeline, and the instruction execution result is obtained by relying on the instruction.

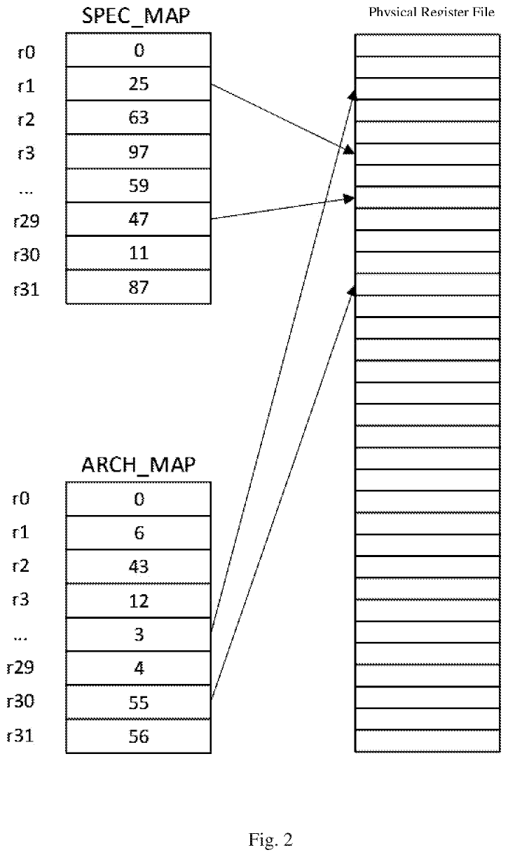

Suppose the architectural registers of the instruction are r0, r1, r2, r3, . . . r31. In the renaming phase, the architectural register of the instruction destination register is mapped to a physical register and updated to the renaming map SPEC_MAP. After the instruction is executed, it is submitted in order in the reordering cache, and the architectural register map of the instruction destination register is updated to ARCH_MAP, as shown in FIG. 2.

In FIG. 2, the mapping table SPEC_MAP in the renaming phase saves the latest physical register mapping relationship of architectural registers r0, r1, r2, . . . r31. When the instruction misprediction or exception refresh occurs, it needs to be restored. ARCH_MAP saves the physical register mapping relationship of r0, r1, r2, . . . r31 after the instruction is submitted. When the reordering cache handles the exception, all the contents of ARCH_MAP are updated to SPEC_MAP, and SPEC_MAP is restored to the state before the exception was refreshed. When misprediction of branch instruction occurs, restore SPEC_MAP according to the reorder cache.

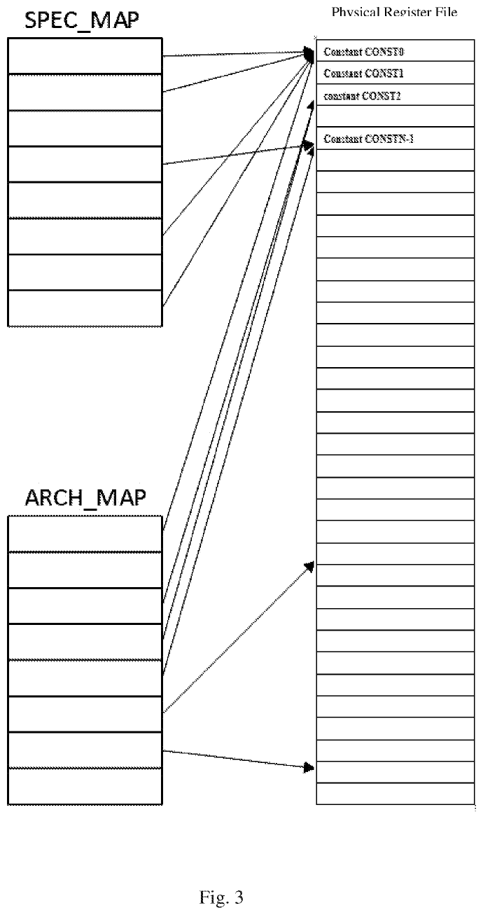

Before register renaming, it can be determined whether the source operand or destination register of the instruction is a fixed constant according to the characteristics of the instruction. For example, the fixed constant value 0, the constant value 1, the constant value, the constant value e, and the logarithm Loge(2) with the constant e as the base 2 often appear in the instruction. This paper proposes to allocate N physical registers dedicated to saving constants in the physical register file. The constants of the physical register file are CONST0, CONST1, CONST2, CONSTN-1, as shown in FIG. 3.

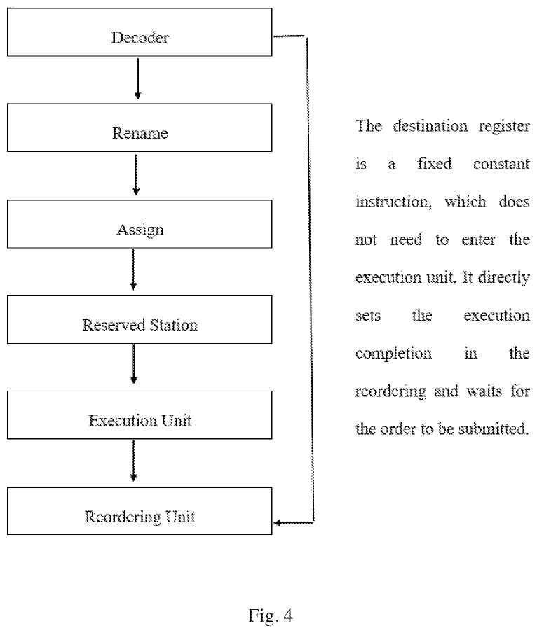

When the source Operand of the instruction is a fixed constant, the physical register of the source register is mapped to the position of the fixed constant. If the execution result of an instruction is a constant, then the instruction does not need to be executed, but maps the physical register of the destination register to the physical register of the fixed constant, and the instruction does not need to allocate a new physical register. No matter what the function of this instruction is, because the result of this instruction can be judged to be a fixed constant, the instruction does not need to be executed, but through a renamed mapping operation, which is completed, as shown in FIG. 4. Through the fixed constant renaming mechanism, not only the physical register resources are saved, but also the instruction does not need to be executed, which greatly improves the execution efficiency of the instruction.

Embodiment 2

The embodiment discloses a renaming method for fixed constant related instructions, the implementation of which is not limited to any instruction set. In order to facilitate the explanation of the principle, the instruction formats listed in Table 1 are two source operands and one destination register. At the same time, it is not limited to the architecture of any processor, and it is also assumed that the instruction processing bandwidth is 4 instructions per clock cycle.

TABLE 1
Instruction judgment fixed constant

| Inst0 | R1_0 | R2_0 | RD_0 |
|---|---|---|---|
| Inst1 | R1_1 | R2_1 | RD_1 |
| Inst2 | R1_2 | R2_2 | RD_2 |
| Inst3 | R1_3 | R2_3 | RD_3 |

Assuming that the 4 instructions inst0, inst1, inst2 and inst3 in the renaming stage perform fixed constant judgment at the same time:

1. First, judging whether the source operand and destination operation of inst0 are fixed constants CONST0, CONST1, CONST2, CONSTN-1. In FIG. 3, it is assumed that the positions of CONST0, CONST1, CONST2, CONSTN-1 in the physical register file are 0, 1, 2, 3, . . . , N−1. When R1_0 or R2_0 in inst0 is a fixed constant, the physical register of R1_0 or R2_0 is mapped to the position of the fixed constant. Assuming that when R1_0 is the fixed constant CONST0, then the value of the physical register is 0; assuming that when R1_0 is the fixed constant CONST1, then the value of the physical register is 1; assuming that when R1_0 is the fixed constant CONST2, then the value of the physical register is 2; assuming that when R1_0 is the fixed constant CONSTN-1, then the value of the physical register is N−1. Similarly, R2_0 also needs to make a similar judgment. If it can be judged that the execution result of inst0 is a fixed constant, these constants are CONST0, CONST1, CONST2, CONSTN-1. Then inst0 does not need to apply for a new free physical register, that is, inst0 only needs to map the SPEC_MAP and ARCH MAP of RD_0 to the position of a fixed constant, and release the physical register that RD_0 was returned in ARCH MAP.

When it is judged that the execution result of inst0 is a constant, then the physical register of RD_0 is mapped to the physical register of this fixed constant. For example, inst0 is an XOR instruction, and R1_0 is equal to R_2_0. At this time, although there is no need to know the specific values of R1_0 and R_2_0, and there is no need to read the physical register file, it can be obtained that the execution result of the instruction is 0, and the physical address mapped by RD_0 is 0. Similarly, if inst0 is an integer division instruction DIV, and the instruction executes RD_0/RD_1, as long as R1_0 is equal to R_2_0 and the value of RD_1 is not 0, then the execution result of this instruction is 1.

When realizing the specific instruction set, according to the characteristics of the instruction, we can judge whether the source Operand of the instruction, that is, the destination register is a fixed constant, and get a similar optimization. The data ready bit corresponding to the Operand whose source Operand is a fixed constant is also valid, that is, the instruction is always in a valid state when the data of the reservation station is ready, and the instruction is sent to the execution unit when the source Operand of other non-fixed constants of the instruction is ready. The physical register addresses of R1_0 and R2_0 are R1_0_phy_reg and R2_0_phy_reg respectively. R1_0_phy_reg and R2_0_phy_reg may be fixed constant physical registers or non-constant physical registers.

2. Then, judge whether the source operand and destination operation of inst1 are fixed constants CONST0, CONST1, CONST2, CONSTN-1. If R1_1 or R2_1 is a fixed constant, R1_1 or R2_1 is mapped to the corresponding fixed constant. When R1_1 is a fixed constant of 0, and R2_1 is not a fixed constant, if inst1 is a MOV instruction at this time, it just satisfies that R2_1 is equal to RD_0, and RD_0 is mapped to a fixed constant. At this time, the physical register RD_1 of inst1 is also mapped to the fixed constant mapped by RD_0, that is, RD_0 and RD_1 are mapped to the same fixed constant. When this happens, RD_0 and RD_1 do not need to apply for the allocation of physical registers, but map the architectural registers of RD_0 and R2_1 to fixed constant physical register addresses, that is, update the mapping relationship between RD_0 and R2_1 in SPEC MAP and ARCH MAP.

As shown in FIG. 3, there are different architectural registers that map to the same fixed constant physical registers. If when R2_1 is not equal to RD_0, and the result of R2_1 is also a constant, then R2_1 is mapped to a different fixed constant physical register address. Inst1 makes a similar judgment to inst0, and obtains various possible fixed constant physical register addresses of the source operand and the destination register.

3. Secondly, judging whether the source operand and destination operation of inst2 and inst3 are fixed constants CONST0, CONST1, CONST2, CONSTN-1. The judgment process of Inst2 is completely similar to that of inst0 and inst, except that it is necessary to judge whether inst2 has the same fixed constant as inst0 and inst1. Similarly, inst3 also needs whether inst3 has the same fixed constant as inst0, inst1 and inst2. The specific judgment process will not be repeated here.

Embodiment 3

This embodiment takes the integer instruction set of RISC-V as an example for description. RISC V's integer instructions include 32 architectural registers: x0, x1, . . . , x31. The value of x0 is fixed at 0. Assuming the bandwidth of the processor is 4 instructions per clock cycle, renaming renames 4 instructions per clock cycle.

TABLE 2
RISC V instruction example

| | | Operand of the | Operand of the | Destination | |
|---|---|---|---|---|---|
| No. | Instruction | first source | second source | register | Description |
| 0 | ADDI | x3 | 122 | X21 | x3 + 122→x21 |
| 1 | ADD | x3 | x5 | x11 | x3 + x5 →x11 |
| 2 | SUB | x11 | x11 | x1 | x11 − x11→x1 |
| 3 | MUL | x7 | x1 | x29 | x7*x1→x29 |
| 4 | LOAD | x21 | 48 | x27 | MEM(x21 + 48)→x27 |
| 5 | MUL | x27 | x29 | x31 | x27*x29→x31 |
| 6 | AMOSWAP.W | x27 | x31 | x24 | MEM(x27)→x24 |
| | | | | | X24→ MEM(x27) |
| 7 | SLTU | x24 | x24 | x30 | When the first source |
| | | | | | operand is less than the |
| | | | | | second source operand, |
| | | | | | set x30 to 1; otherwise, |
| | | | | | set it to 0. |
| | . . . | | | | |

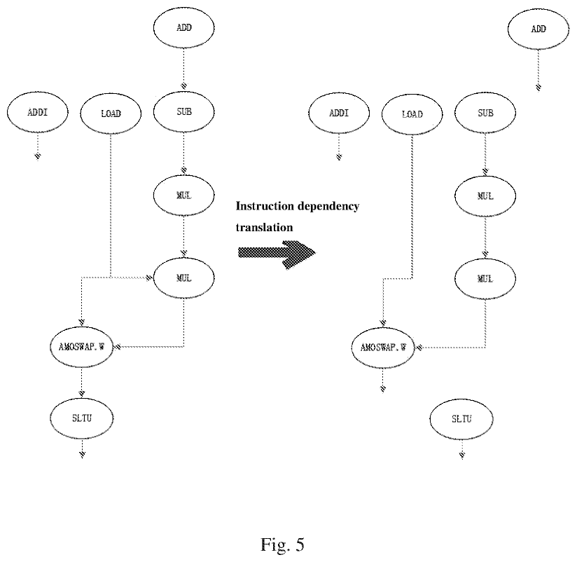

The dependency between ordinal 0 and ordinal 7 instructions is shown in FIG. 5. As shown. According to the normal process, there are dependent instructions that can only be executed after getting the data, otherwise they can only be in the no-ready state. Depending on whether the execution result of the instruction is constant, and after renaming the fixed constant, the dependency of some instructions can be cancelled. And the execution process of the instruction is completed by the renaming method of fixed constant.

The SUB instruction of sequence number 2 subtracts, and the first source Operand minus the second source Operand. Since both operands are x11, regardless of the specific value of x11, the execution result of the SUB instruction is 0. SUB instructions can be renamed to remove the dependency between SUB and ADD instructions, as shown in FIG. 5. And the destination register x1 of SUB does not need to allocate physical registers, update the physical register of x1 mapping in the SPEC_map table to CONST0, and set the execution completion signal of SUB in the reordering cache to 1.

When committing SUB in the reorder cache, release the physical register of x1 in ARCH_MAP and update the physical register of xl in ARCH_MAP to x0. The MUL instruction with sequence number 3 performs multiplication operation. Because the execution result of the SUB instruction in the current cycle is a constant CONST0, the result of the MUL instruction is also a constant CONST0. The mapping of MUL destination register x29 in SPEC_MAP is updated to the physical register address of CONST0. In addition, MUL does not need to enter the multiplication execution unit for execution, but directly updates the execution completion signal in the reorder cache and waits for submission.

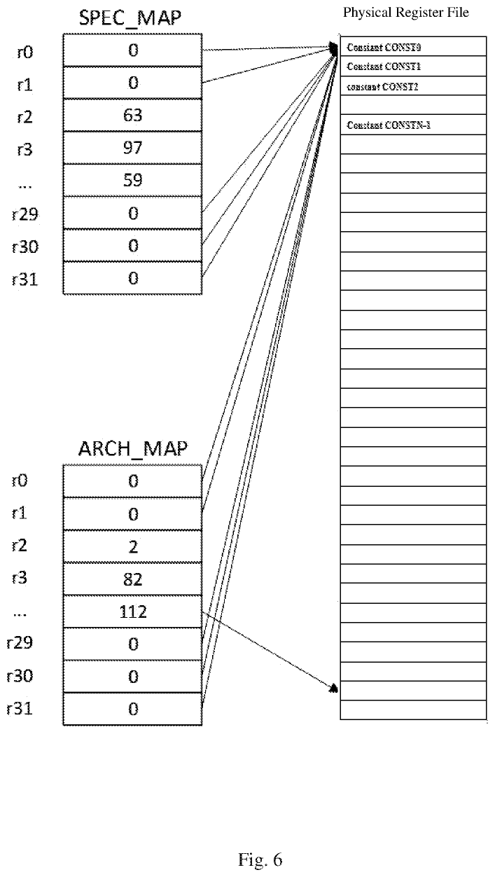

When the MUL commits in the reorder cache, the mapping of the schema register x29 is updated to x0, and the physical registers prior to x29 are released. The multiplication instruction with sequence number 5 also removes the dependency from the LOAD instruction with sequence number 4, and the execution result of the instruction is also CONST0. Therefore, the multiplication instruction with sequence number 5 is similar to the multiplication instruction with sequence number 3 and will not be repeated. The atomic operation instruction AMOSWAP.W with sequence number 6 can also get the value of the second source register x31 as CONST0. The set instruction SLTU with sequence number 7 can also judge that the result of instruction execution is 0, because both source operands are x24, no matter what the value of x24 is, the result of instruction execution is 0. Therefore, SLTU does not need to be executed, but updates the mapping of x30 in SPEC_MAP to x0, which is CONST0, as shown in FIG. 6.

These instructions mapped to the constant CONST0 not only do not need to allocate new physical registers, but also do not need to be assigned to the reservation station and the execution unit, which greatly improves the execution efficiency of the instructions and the processor can accommodate more instructions. Especially for instructions that take a long time to execute, such as MUL, LOAD and AMO instructions, instructions that depend on these instructions can be renamed

The floating-point instruction register defined by the X86 instruction set is a stack with a depth of 8 and a width of 80. The stack is represented by ST and the top of the stack is ST (0). When writing to the stack, the PUSH operation is performed on the stack. The constant-related instructions defined by X86 are shown in Table 3.

TABLE 3
X86 floating point constant instructions

| | Operand of the | Operand of the | Destination | |
|---|---|---|---|---|
| Instructions | first source | second source | register | Description |
| FLDZ | 0.0 | None | ST(0) | ST is the floating-point |
| | | | | register stack, and the |
| | | | | value at the top of the |
| | | | | stack is written as a |
| | | | | constant 0.0 |
| FLD1 | +1.0 | None | ST(0) | The value at the top of |
| | | | | the stack is written as a |
| | | | | constant +1.0 |
| FLDPI | π | None | ST(0) | Write constant to the |
| | | | | value on the top of the |
| | | | | stack π |
| FLDL2T | Log2(10) | None | ST(0) | The value at the top of |
| | | | | the stack is written as |
| | | | | the constant 2 as the |
| | | | | logarithm of the base |
| | | | | 10 |
| FLDL2E | Log2(e) | None | ST(0) | The value at the top of |
| | | | | the stack is written as |
| | | | | the constant 2 as the |
| | | | | logarithm of the base e |
| FLDLG2 | Log10(2) | None | ST(0) | The value at the top of |
| | | | | the stack is written as |
| | | | | the constant base 10 |
| | | | | logarithm of 2 |
| FLDLN2 | Loge(2) | None | ST(0) | The value at the top of |
| | | | | the stack is written as |
| | | | | the logarithm of the |
| | | | | base 2 with the |
| | | | | constant e |

The width of constants in X86 floating-point instructions is related to the mode of the processor. If these constants follow the instructions in the pipeline, a lot of hardware resources will be consumed in the pipeline. Using the renaming method proposed in this paper, these constants can not only reduce hardware resources, but also save physical registers and improve instruction execution efficiency. The specific implementation is completely similar to the example of RISC V instruction set, which will not be discussed in detail in this article.

Embodiment 4

The present embodiment discloses a renaming system for fixed constant related instructions, comprising a register, a decoder and an execution unit. The register includes an architecture register and a physical register. In the renaming phase, the architecture register of the instruction destination register is mapped to a physical register and updated to the rename mapping table SPEC_MAP. After the instruction execution is completed, the instruction is submitted sequentially in the reorder cache, and the architecture register of the instruction destination register is mapped and updated to ARCH_MAP.

In summary, the invention classifies the instructions, and the fixed constant instructions do not need to enter the execution unit, but realize the execution of the instructions through the renaming method, and the instruction execution efficiency is high.

The above embodiments are only used to illustrate the technical scheme of the invention, not to limit it; although the invention is described in detail with reference to the aforementioned embodiments, ordinary technicians in the field should understand that they can still modify the technical scheme recorded in the above-mentioned embodiments, or equivalent replacement of some of the technical features. These modifications or replacements do not deviate the essence of the corresponding technical scheme from the spirit and scope of the technical scheme of the embodiments of the present invention.

1-9. (canceled)

10. A method for renaming a plurality of instructions related to fixed constants, wherein the method comprises the following steps:
step S1: classifying, by a decoder, the plurality of instructions according to characteristics of the plurality of instructions and selecting instructions with fixed constants;
step S2: in a renaming phase, mapping a source register and a destination register of the selected instructions in S1 to different fixed constant physical registers according to different fixed constants;
step S3: updating register renamed mapping tables SPEC_MAP and ARCH_MAP to release a physical register corresponding to a fixed constant when a selected instruction of the selected instructions is committed;
step S4: reading a physical register stack according to a physical register of the source register or obtaining a source operand by using an instruction execution result of a Forward. channel of an execution unit;
step S5: when the execution unit is completed, writing a physical register stack according to a physical register of the destination register; and
step S6: carring the instruction execution result of the Forward channel to a pipeline, depending on an instruction of the plurality of instructions to get the instruction execution result, and then implementing a function of the instruction of the plurality of instructions.

11. The method according to claim 10, wherein:
each of the plurality of instructions obtains the physical register of the source register and the physical register of the destination register in the renaming phase;
the physical register of the source register is obtained from the renamed mapping table SPEC MAP or a free physical register queue according to a correlation of the instruction; and
the physical register of the destination register is a newly allocated free physical register, which is obtained from a free physical register queue.

12. The method according to claim 10, further comprising, before the register is renamed, according to the characteristics of the selected instruction, determining whether the source operand or the destination register of the selected instruction is a fixed constant, and determining whether the fixed constant has a value of 0, a value of 1, a value of e, a value of logarithm Logₑ (2) with the constant e being the base.

13. The method according to claim 10, wherein:
instructions inst0, inst1, inst2 and inst3 in the renaming phase are simultaneously determined with fixed constants to determine whether the source operand and destination operation of inst0 are fixed constants CONST0, CONST1, CONST2, CONSTN-1;
when R1_0 or R2_0 in inst0 is a fixed. constant, the physical register of R1_0 or R2_0 is mapped to the position of the fixed constant;
if R1_0 is a fixed constant CONST0, the value of the physical register is 0;
if R1_0 is a fixed constant CONST1, the value of the physical register is 1;
if R1_0 is a fixed constant CONST2, the value of the physical register is 2; and
if R1_0 is a fixed constant CONSTN-1, the value of the physical register is N−1.

14. The method according to claim 13, wherein:
when determining R2_0, if execution result of the inst0 is determined to be a fixed constant, the inst0 does not need to apply for a new free physical register, and the inst0 maps the SPEC_MAP and the ARCH_MAP of RD_0 to the position of the fixed constant;
when determining that the execution result of inst0 is a constant, the physical register of RD_0 is mapped to a physical register of the fixed constant; and
when implementing an instruction set, according to characteristics of the instruction, it is determined whether the source operand of the instruction and the destination register, are fixed constants.

15. The method according to claim 13, wherein:
it is determined whether the source operand and destination operation of inst1, inst2 and inst3 are fixed constants CONST0, CONST1, CONST2, . . . , CONSTN-1;
if R1_1 or R2_1 is a fixed constant, R1_1 or R2_1 is mapped to a corresponding fixed constant;
when R1_1 is a fixed constant 0, and R2_1 is not a fixed constant, if inst1 is a MOV instruction at this time, R2_1 is equal to RD_0, and RD_0 is mapped to a fixed constant;
a physical register RD_1 of inst1 is also mapped to the fixed constant mapped by RD_0; RD_0 and RD_1 are mapped to the same fixed constant, architectural registers of RD_0 and R2_1 are mapped to a physical register address of the fixed constant, and a mapping relationship between RD_0 and R2_1 in SPEC_MAP and ARCH_MAP is updated;
it is determined whether inst2 has the same fixed constant as inst0 and inst1, and whether inst3 has the same fixed constant as inst0, inst1, and inst2.

16. The method according to claim 10, wherein:
the instructions include source operands and destination registers;
all source operands are obtained before an instruction enters the execution unit for execution;
after the operands of instructions in a reserved station are prepared, they are sent to the execution unit for execution; and
after the execution is completed, the execution result is written to the destination register and committed in order.

17. A system for renaming instructions related to fixed constants, the system comprises a register, a decoder, and an execution unit, the system being configured to perform a process comprising the following steps:
step S1: classifying, by a decoder, the plurality of instructions according to characteristics of the plurality of instructions and selecting instructions with fixed constants;
step S2: in a renaming phase, mapping a source register and a destination register of the selected instructions in S1 to different fixed constant physical registers according to different fixed constants;
step S3: updating register renamed mapping tables SPEC_MAP and ARCH_MAP to release a physical register corresponding to a fixed constant when a selected instruction of the selected instructions is committed;
step S4: reading a physical register stack according to a physical register of the source register or obtaining a source operand by using an instruction execution result of a Forward channel of an execution unit;
step S5: when the execution unit is completed, writing a physical register stack according to a physical register of the destination register; and
step S6:carring the instruction execution result of the Forward channel to a pipeline, depending on an instruction of the plurality of instructions to get the instruction execution result, and then implementing a function of the instruction of the plurality of instructions.

18. The system according to claim 17, wherein:
each of the plurality of instructions obtains the physical register of the source register and the physical register of the destination register in the renaming phase;
the physical register of the source register is obtained from the renamed mapping table SPEC_MAP or a free physical register queue according to a correlation of the instruction; and
the physical register of the destination register is a newly allocated free physical register, which is obtained from a free physical register queue.

19. The system according to claim 17, wherein the process further comprising, before the register is renamed, according to the characteristics of the selected instruction, determining whether the source operand or the destination register of the selected instruction is a fixed constant, and determining whether the fixed constant has a value of 0, a value of 1, a value of e, a value of logarithm Logₑ (2) with the constant e being the base.

20. The system according to claim 17, wherein:
instructions inst0, inst1, inst2 and inst3 in the renaming phase are simultaneously determined. with fixed constants to determine whether the source operand and destination operation of inst0 are fixed constants CONST0, CONST1, CONST2, CONSTN-1;
when R1_0 or R2_0 in inst0 is a fixed constant, the physical register of R1_0 or R2_0 is mapped to the position of the fixed constant;
if R1_0 is a fixed constant CONST0, the value of the physical register is 0;
if R1_0 is a fixed constant CONST1, the value of the physical register is 1;
if R1_0 is a fixed constant CONST2, the value of the physical register is 2; and
if R1_0 is a fixed constant CONSTN-1, the value of the physical register is N−1.

21. The system according to claim 20, wherein:
when determining R2_0, if execution result of the inst0 is determined to be a fixed constant, the inst0 does not need to apply for a new free physical register, and the inst0 maps the SPEC_MAP and the ARCH_MAP of RD_0 to the position of the fixed constant;
when determining that the execution result of inst0 is a constant, the physical register of RD_0 is mapped to a physical register of the fixed constant; and
when implementing an instruction set, according to characteristics of the instruction, it is determined whether the source operand of the instruction and the destination register, are fixed constants.

22. The system according to claim 20, wherein:
it is determined whether the source operand and destination operation of inst1, inst2 and inst3 are fixed constants CONST0, CONST1, CONST2, . . . , CONSTN-1;
if R1_1 or R2_1 is a fixed constant, R1_1 or R2_1 is mapped to a corresponding fixed constant;
when R1_1 is a fixed constant 0, and R2_1 is not a fixed constant, if inst1 is a MOV instruction at this time, R2_1 is equal to RD_0, and RD_0 is mapped to a fixed constant;
a physical register RD_1 of inst1 is also mapped to the fixed constant mapped by RD_0; RD_0 and RD_1 are mapped to the same fixed constant, architectural registers of RD_0 and R2_1 are mapped to a physical register address of the fixed constant, and a mapping relationship between RD_0 and R2_1 in SPEC_MAP and ARCH_MAP is updated;
it is determined whether inst2 has the same fixed. constant as inst0 and inst1, and whether inst3 has the same fixed constant as inst0, inst1, and inst2.

23. The method according to claim 17, wherein:
the instructions include source operands and destination registers;
all source operands are obtained before an instruction enters the execution unit for execution;
after the operands of instructions in a reserved station are prepared, they are sent to the execution unit for execution; and
after the execution is completed, the execution result is written to the destination register and committed in order.

24. The system according to claim 17, wherein:
the register includes an architecture register and a physical register;
in the renaming phase, the architecture register of the instruction destination register is mapped to a physical register and updated to the rename mapping table SPEC_MAP; and
after the instruction execution is completed, it is committed sequentially in the reorder cache, and the architecture register of the instruction destination register is updated to ARCH_MAP.
